(19) United States
(12) Patent Application Publication
(10) Pub. No.: US 2002/0121153 A1
(43) Pub. Date: Sep. 5, 2002

(54) Steering column assembly having a stationary central cushion, and a corresponding motor vehicle

(76) Inventor: Andre Hoblingre, Roppe (FR)

Correspondence Address: YOUNG & THOMPSON, 745 SOUTH 23RD STREET 2ND FLOOR, ARLINGTON, VA, 22202

(21) Appl. No.: 10/082,143

(22) Filed: Feb. 26, 2002

(30) Foreign Application Priority Data
Feb. 27, 2001 (FR) 01 02669

(51) Int. Cl. B62D 1/16

(52) U.S. Cl. 74/492; 74/498

(57) ABSTRACT

A steering column assembly of the type comprising a steering shaft extending along a longitudinal direction and comprising a front segment and a rear segment, a gear mechanism for transmitting rotary movement of the rear segment as produced by a steering wheel to the front segment, a stationary block for mounting a central cushion to prevent it from turning while the steering shaft is turning, the gear mechanism comprising a front toothed member connected to the front segment of the steering shaft, a rear toothed member connected to the rear segment of the steering shaft, and an intermediate toothed member having a front toothed portion meshing with the front toothed member and a rear toothed portion meshing with the rear toothed member. The teeth of the front toothed portion of the intermediate toothed member are angularly offset relative to the teeth of its rear toothed portion.

The present invention relates to a steering column assembly for a motor vehicle, the assembly being of the type comprising a steering shaft extending along a longitudinal direction and comprising a front segment and a rear segment, a gear mechanism for transmitting rotary movement of the rear segment as produced by a steering wheel to the front segment, a stationary block for mounting a central cushion to prevent it from turning while the steering shaft is turning, the gear mechanism comprising a front toothed member connected to the front segment of the steering shaft, a rear toothed member connected to the rear segment of the steering shaft, and an intermediate toothed member having a front toothed portion meshing with the front toothed member and a rear toothed portion meshing with the rear toothed member.

### BACKGROUND OF THE INVENTION

A steering column assembly of the above-specified type enables the steering wheel to turn the steering shaft while keeping stationary the cushion located at the center of the steering wheel.

Such a stationary central cushion generally carries various accessories, including an airbag, a switch for controlling a horn, and other control members for various pieces of functional equipment in the vehicle.

An assembly of the above-specified type is disclosed in document FR-2 782 971, for example. In that document, the front and rear toothed members are sleeves having coaxial inwardly-directed teeth centered on the longitudinal axis of the steering shaft. The intermediate toothed member is an elongate gearwheel having outwardly-directed teeth, which gearwheel is disposed inside the toothed sleeves and is eccentric relative to the longitudinal axis of the steering shaft. The intermediate gearwheel is mounted to rotate in two bearings made in a flexible rubbery material. These bearings hold the intermediate gearwheel pressed against the front and rear toothed sleeves, and thus take up any radial slack that might appear between them.

In that assembly, radial slack is indeed taken up, but it is found in practice that the torque that needs to be applied to the steering wheel in order to turn the steering shaft oscillates strongly about a mean value. This variation, which is of a period that corresponds to the pitch of the teeth of the intermediate gearwheel, is due to the fact that the pitch circles of the toothed sleeves and of the intermediate gearwheel are not tangential, which would ensure ideal meshing, but intersect because the intermediate gearwheel is held against the sleeves.

This large amplitude variation makes driving uncomfortable and, for example, can prevent a driver from turning the steering shaft accurately.

### OBJECTS AND SUMMARY OF THE INVENTION

An object of the invention is to resolve that problem by supplying an assembly of the above-specified type in which the torque required for turning the steering shaft varies with small amplitude.

To this end, the invention provides a steering column assembly of the above-specified type, wherein the teeth of the front toothed portion of the intermediate toothed member are angularly offset relative to the teeth of its rear toothed portion.

In particular embodiments, the assembly may comprise one or more of the following characteristics taken singly or in any technically feasible combination:

the radial mid plane of each tooth of the front toothed portion is firstly disposed in register with a space between two adjacent teeth of the rear toothed portion, and is secondly spaced angularly relative to the radial mid plane of said two adjacent teeth,

the front and rear toothed portions both possess the same number of teeth that are spaced apart at the same pitch, and the teeth of the front toothed portion are offset by half of one pitch step relative to the teeth of the rear toothed portion,

the steering column assembly further comprises holding means for holding the intermediate toothed member radially against the teeth of the front and rear toothed members,

the holding means comprise a return member for resiliently urging the intermediate toothed member against the front and rear toothed members,

the holding means comprise a ramp surface mechanism for transforming a longitudinal component of a force produced by the resilient return member into a radial force urging the intermediate toothed member against the front and rear toothed members,

the ramp surface mechanism includes a support for supporting the intermediate toothed member, which support is received to move radially relative to the stationary block,

the resilient return member is a compression spring disposed longitudinally; and

the front and rear toothed members are sleeves having inwardly-directed teeth, and the intermediate toothed member is a gearwheel having outwardly-directed teeth and disposed inside the front and rear toothed members.

The invention also provides a motor vehicle including an assembly as defined above.

### BRIEF DESCRIPTION OF THE DRAWINGS

The invention will be better understood on reading the following description given purely by way of example and made with reference to the accompanying drawings, in which:

FIG. 1 is a fragmentary diagrammatic view in longitudinal section through a steering column assembly of the invention, with two rectangular portions shown on a larger scale;

FIG. 2 is a diagrammatic end view of the intermediate toothed member of the FIG. 1 assembly; and

FIGS. 3 and 4 are respectively a theoretical and a practical set of curves showing the variation in the torque that needs to be applied to turn the steering shaft in the FIG. 1 assembly.

### MORE DETAILED DESCRIPTION

The terms “front” and “rear” are used below relative to the travel direction of the motor vehicle and to the position of the driver.

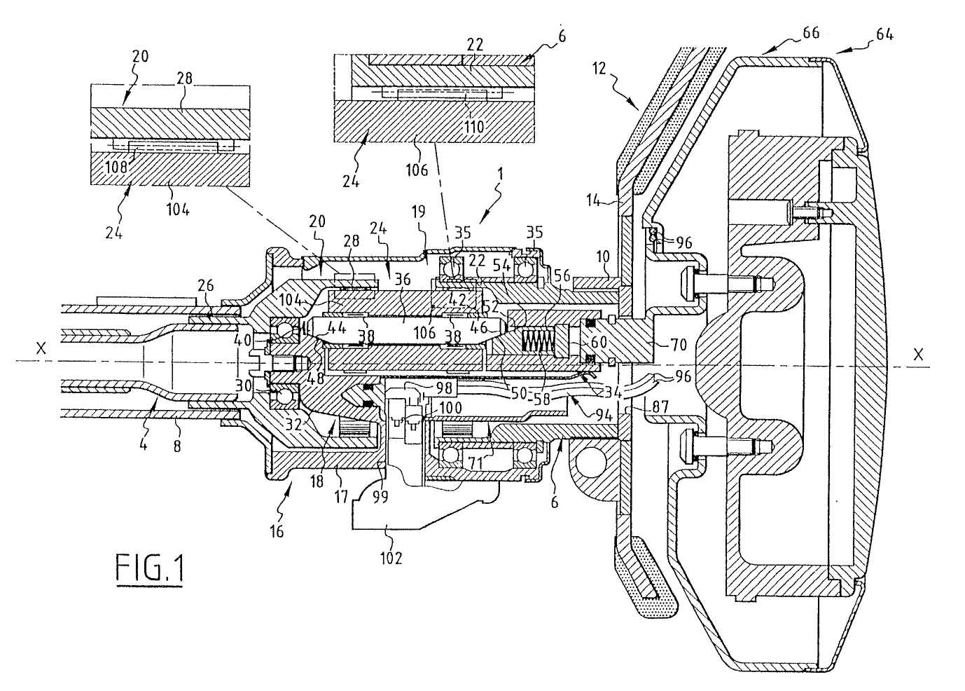

FIG. 1 shows a steering column assembly 1 for a motor vehicle, the assembly comprising a steering shaft of longitudinal axis X-X and of general structure analogous to that described in FR-2 782 971.

The steering shaft itself has a front segment 4 (to the left in FIG. 1) and a rear segment 6.

The front segment 4, which can be built up from a plurality of parts as shown in FIG. 1, is received in conventional manner to rotate in a steering column body 8 carried by the structure of the motor vehicle.

The rear segment 6 of the steering shaft is connected to the hub 10 of a steering wheel 12 so as to be constrained to rotate together therewith. This connection is provided in conventional manner, e.g. by radial locking via a conical screw. The steering wheel 2 has an annual rim (not shown) rigidly connected to the hub 10 by a plurality of branches 14 that are angularly disposed around the hub.

The steering column assembly 1 also comprises a stationary body or block 16 placed between the front and rear segments 4 and 6 of the steering shaft. The stationary body 16 comprises an outer skirt or casing 17 that is generally cylindrical in shape about the axis X-X, and a central core 18 rigidly connected to the skirt 17. The body 16 is rigidly connected to the remainder of the vehicle structure via its skirt 17 in such a manner as to remain stationary while the steering shaft is being turned by the steering wheel 12.

The assembly 1 also has a gear mechanism 19 for transmitting the rotary movement of the rear segment 6 of the steering shaft to the front segment 4. The mechanism 19 comprises a front toothed member 20 in the form of a bell, a rear toothed member 22, and an intermediate toothed member 24 in the form of an elongate gearwheel.

The front end 26 of the bell 20 is constrained to rotate with the rear end of the front segment 4 of the steering shaft.

The rear end 28 of the bell 20 forms a sleeve having inwardly-directed teeth. The bell 20 is centered on the axis X-X and is mounted to rotate, e.g. by means of a ball-bearing 30, on the front end 32 of the central core 18 of the fixed body 16, this front end 32 being received inside the toothed sleeve 28 of the bell 20.

The rear segment 6 of the steering shaft is a sleeve surrounding the rear end 34 of the core 18 of the fixed body 16 and received in the rear end of the skirt 17 of the stationary body 16. Two ball-bearings 35 are interposed between the outer wall of the rear segment 6 of the steering shaft and the inner wall of the skirt 17 so as to enable the rear segment 16 to turn about the axis X-X relative to the body 16, and so as to prevent the rear segment 6 from moving axially relative to the stationary body 16.

The rear toothed member 22 is formed by the front end of the rear segment 6 of the steering shaft which has inwardly-directed teeth.

The intermediate gearwheel 24 extends rearwards from the inside of the front toothed sleeve 28 to the inside of the rear toothed sleeve 22.

This gearwheel 24 is mounted on the hub 18 via a longitudinal support rod 36 placed inside the intermediate gearwheel 24. By way of example, two needle bearings 38 are interposed between the gearwheel 34 and rod 36. The rod 36 and the gearwheel 24 can move radially relative to the core 18.

The front and rear ends 40 and 42 of the rod 36 project longitudinally outside the intermediate gearwheel 24. Each of these ends presents a respective ramp surface 44 or 46. The two first ramp surfaces 44 and 46 are inclined in opposite directions relative to the longitudinal axis X-X, e.g. at an angle of about 20°, and more generally at an angle lying in the range 10° to 40°. Thus, the front first ramp surface 44 is inclined radially outwards and forwards, while the rear first ramp surface 46 is inclined radially outwards and rearwards.

The first ramp surfaces 44 and 46 bear respectively against second ramp surfaces 48 and 50 that are inclined in corresponding manner.

The front second ramp surface 48, which co-operates with the front first ramp surface 44 of rod 36 is formed in the front end 32 of the core 18. The rear second ramp surface 50, which co-operates with the rear first ramp surface 46 of the rod 36 is formed at the front of a pusher 52 received in a longitudinal bore 54 formed in the rear end 34 of the core 18 of the stationary body 16.

The pusher 52 can slide axially in the bore 54. A blind axial orifice 56 is formed behind the pusher 52 and receives a helical return spring 58, which bears against the end wall of the orifice 56 and against a screw 60 that is screwed into the bore 54, behind the pusher 52. The spring 58 thus returns the pusher 52 towards the front of the steering column assembly 1.

The steering column assembly 1 also comprises, in the center of the steering wheel 12, a stationary central cushion 64, which comprises a support shell 66, e.g. made as a single piece of plastics material filled with glass fibers, or else of aluminum or of magnesium. The stationary central cushion 64 carries, in particular, an airbag (not shown) and members (not shown) for controlling pieces of functional equipment of the vehicle.

The shell 66 is extended forwards by a cylindrical peg 70 and a plug or tail 71 which extends parallel to the axis X-X.

The peg 70 is considerably shorter than the plug 71. The peg 70 and the plug 71 are disposed eccentrically about the axis X-X, and they are offset angularly by approximately 180° about said axis.

The peg 70 is received through a central orifice 87 of the hub 10 in the bore 54 at the rear end 34 of the core 18 of the stationary body 16, behind the screw 60.

The plug 71 is received through the central orifice 87 of the hub 10 in a longitudinal recess of shape corresponding to core 18 of the stationary body 16.

The peg 70 and the plug 71 provide radial centering and relative angular positioning for the central cushion 61 and the stationary body 16.

Internally, the plug 71 defines an axial passage 94 for a bundle of electrical conductor wires 96 coming from the various control members carried by the stationary central cushion 64, and in particular those which are received in the shell 66. The conductor bundle 96 is terminated at its front end by a female connector 98 facing radially outwards in register with an opening in the plug 71. This opening looks into a radial passage 99 formed in the body 16 between the hub 18 and the skirt 17 of the fixed body 16. A male connector 100 complementary to the female connector 99 is received in the radial passage 99 to connect the electrical conductors 96 to the corresponding pieces of equipment of the vehicle.

In conventional manner, the male connector 100 can be locked in position by a pivoting lever 102 which, in its locked position as shown in FIG. 1, is pressed against the rear bottom portion of the skirt 17 of the fixed body 16.

It should be observed that in FIG. 1, the connectors 98 and 100, and the lever 102 are not shown in section.

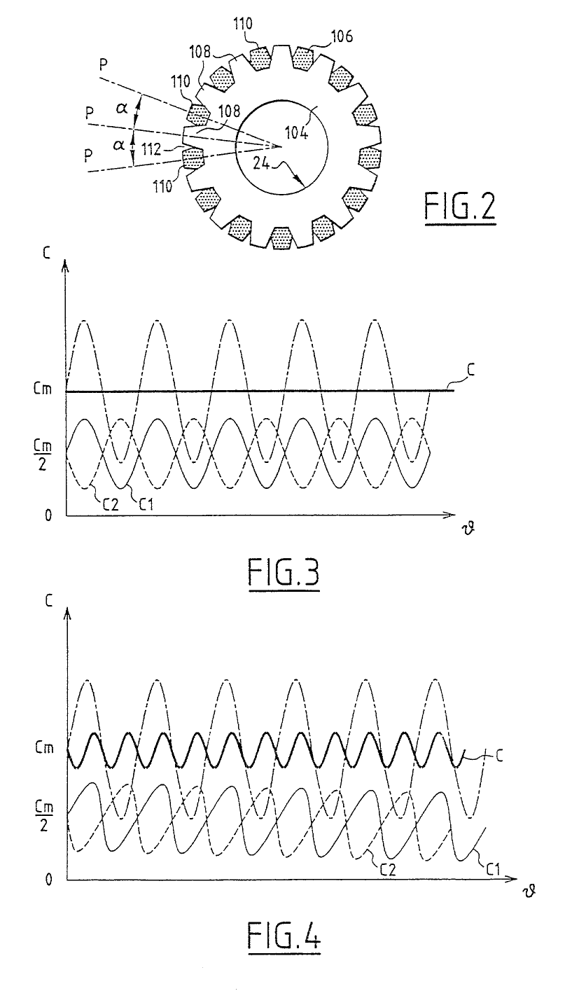

As shown more particularly by the enlarged portions of FIG. 1 and by FIG. 2, the intermediate gearwheel 24 has a front toothed portion 104 meshing with the front toothed sleeve 28, and a rear toothed portion 106 meshing with the rear toothed sleeve 22. The intermediate gearwheel 24 has no teeth between its front and rear portions 104 and 106.

The front and rear portions 104 and 106 have the same numbers of teeth, and their teeth are spaced apart at the same pitch. These teeth are rectilinear and they extend parallel to the axis X-X.

The teeth 108 of the front toothed portion 104 are angularly offset relative to the teeth 110 of the rear toothed portion 106 by half of the pitch.

Thus, the radial mid plane P of a front tooth 108 lies longitudinally in register with a space 112 between two adjacent rear teeth 110. The plane P of the front tooth 108 in question is spaced apart from the radial mid planes P of the two adjacent rear teeth 110 by substantially the same angle α.

When the driver turns the steering wheel 12 about the axis X-X, the steering wheel acts via the hub 10 to turn the rear segment 6 of the steering shaft about the longitudinal axis X-X. The rear toothed sleeve 22 which meshes with the intermediate gearwheel 24 turns it about the eccentric rod 36. The intermediate gearwheel 24, which also meshes with the front toothed sleeve 28, then turns said sleeve. Since the sleeve 28 is constrained to rotate with the front segment 4 of the steering shaft, rotary movement imparted to the steering wheel 12 is transmitted via the gear mechanism 19 to the front segment 4 of the steering shaft.

The first ramp surfaces 44 and 46, the second ramp surface 48 and 50, and the return spring 58 serve to absorb the radial slack between the teeth of the intermediate gearwheel 24 and the teeth of the front and rear sleeves 28 and 22.

The spring 58 exerts a forwardly-directed axial force on the pusher 52. Because of the inclination of the rear ramp surfaces 46 and 50 and of the front ramp surfaces 44 and 48, this longitudinal force is transformed into a radial return force tending to move the gearwheel 24 radially outwards, and thus to press it against the front and rear toothed sleeves 28 and 22.

A small longitudinal space between the rear end of the pusher 52 and the screw 60 allows the pusher 52 to move rearwards a little, and thus allows it to move a short way radially towards the inside of the gearwheel 24 against the action of the spring 58. This characteristic makes it possible to take up small manufacturing defects in the intermediate gearwheel 24 and in the front and rear toothed sleeves 28 and 22.

The screw 60 serves to adjust the amplitude of this potential for radial displacement of the gearwheel 24.

The use of ramp surfaces 44, 46, 48 and 50, which transform a longitudinal return force into a radial return force, makes it possible to place the spring 58 longitudinally within the steering column assembly 1. This ensures that the radial size of the assembly 1 is small, while still providing satisfactory take up of radial slack.

Furthermore, the ramp surfaces 44, 46, 48 and 50 make it possible to use a weaker spring 58, which therefore occupies less space than would be required by a radial spring, since the axial spring 58 need only compensate the axial component of the contact force between the rod 56 and the pusher 52.

In addition, the mechanism for holding the gearwheel 24 radially against the teeth of the front and rear sleeves 28 and 22 is less sensitive to aging than is a mechanism using bearings made of flexible rubbery material having the rod 36 mounted therein.

In addition, the torque needed to turn the steering shaft 12 about the longitudinal axis X-X varies to a small extent only, as explained below, with reference to FIGS. 3 and 4.

In FIG. 3, continuous line curve Cl shows the torque required for transmitting rotation between a first toothed sleeve and the corresponding toothed portion of the intermediate gearwheel 24, as a function of angle of rotation θ. This curve C1 is substantially sinusoidal, and it oscillates about a mean value Cm/2 with a period that corresponds to the pitch of the teeth of the intermediate gearwheel 24.

In the state of the art, since the teeth of the intermediate gearwheel 24 are in alignment, the torque needed to transmit rotation between the intermediate gearwheel and the other toothed sleeve also varies as shown by curve C1. The total driving torque required to turn the steering shaft thus varies in the manner shown by the chain-dotted curve and corresponds to twice the curve C1. This curve is substantially sinusoidal and oscillates about a mean value Cm. The amplitude of variation in the total torque is twice that of curve C1.

In contrast, in the assembly shown in FIGS. 1 and 2, dashed-line torque curve C2 corresponding to the intermediate gearwheel 24 meshing with the other toothed sleeve is in phase opposition with curve C1. This is because of the angular offset between the front teeth 108 and the rear teeth 110 of the intermediate gearwheel 24.

The variation of the curve C2 thus compensates the variation of the curve C1 such that the overall torque C (continuous line) needed to turn the steering shaft is substantially constant and equal to about Cm.

That is how the assembly 1 ought to operate in theory. In practice, the curves C1 and C2 are not truly sinusoidal, and so their variations compensate in part only, such that the curve showing the total torque C does still oscillate about the value Cm, but the amplitude with which it varies is considerably smaller than that of the chain-dotted curve corresponding to the state of the art. It should also be observed that the period of these variations is substantially half that of the period of the variations in the curves C1 and C2.

Thus, driving discomfort is reduced and the steering shaft can be turned more accurately.

The principles described above can be used with other types of gear mechanism 19, e.g. those comprising an intermediate toothed member in the form of a sleeve having inwardly-directed teeth and front and rear toothed members in the form of gearwheels having outwardly-directed teeth.

Furthermore, the intermediate gearwheel 24 can have teeth of a type other than the rectilinear teeth described, and the angular offset between the front teeth 108 and the rear teeth 110 is not necessarily half of one pitch step.

In general, these principles can also be applied to steering column assemblies that do not have means for holding the intermediate toothed member radially against the front and rear toothed members.

1/ A steering column assembly of the type comprising a steering shaft extending along a longitudinal direction and comprising a front segment and a rear segment, a gear mechanism for transmitting rotary movement of the rear segment as produced by a steering wheel to the front segment, a stationary block for mounting a central cushion to prevent it from turning while the steering shaft is turning, the gear mechanism comprising a front toothed member connected to the front segment of the steering shaft, a rear toothed member connected to the rear segment of the steering shaft, and an intermediate toothed member having a front toothed portion meshing with the front toothed member and a rear toothed portion meshing with the rear toothed member, wherein the teeth of the front toothed portion of the intermediate toothed member are angularly offset relative to the teeth of its rear toothed portion.

2/ An assembly according to claim 1, wherein the radial mid plane of each tooth of the front toothed portion is firstly disposed in register with a space between two adjacent teeth of the rear toothed portion, and is secondly spaced angularly relative to the radial mid plane of said two adjacent teeth by substantially the same angle.

3/ An assembly according to claim 2, wherein the front and rear toothed portions both possess the same number of teeth that are spaced apart at the same pitch, and wherein the teeth of the front toothed portion are offset by half of one pitch step relative to the teeth of the rear toothed portion.

4/ An assembly according to claim 1, wherein the steering column assembly further comprises holding means for holding the intermediate toothed member radially against the teeth of the front and rear toothed members.

5/ An assembly according to claim 4, wherein the holding means comprise a return member for resiliently urging the intermediate toothed member against the front and rear toothed members.

6/ An assembly according to claim 5, wherein the holding means comprise a ramp surface mechanism for transforming a longitudinal component of a force produced by the resilient return member into a radial force urging the intermediate toothed member against the front and rear toothed members.

7/ An assembly according to claim 1, wherein the ramp surface mechanism includes a support for supporting the intermediate toothed member, which support is received to move radially relative to the stationary block.

8/ An assembly according to claim 1, wherein the resilient return member is a compression spring disposed longitudinally.

9/ An assembly according to claim 1, wherein the front and rear toothed members are sleeves having inwardly-directed teeth, and wherein the intermediate toothed member is a gearwheel having outwardly-directed teeth and disposed inside the front and rear toothed members.

10/ A motor vehicle, including an assembly according to claim 1.
